(19) United States
(12) Patent Application Publication
(10) Pub. No.: US 2006/0064256 A1
(43) Pub. Date: Mar. 23, 2006

(54) Method and system for controlling the operation of devices in a hydrocarbon production system

(76) Inventors: David Eric Appleford, Essex (GB); Brian William Lane, Essex (GB)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 10/518,170

(22) PCT Filed: Jun. 27, 2003
(86) PCT No.: PCT/GB03/02787

§ 371 Date: Dec. 15, 2004

(30) Foreign Application Priority Data
Jun. 28, 2002 (GB) 0215065.4

(51) Int. Cl. G01N 27/00

(52) U.S. Cl. 702/31

(57) ABSTRACT

A system for controlling the operation of devices (61, 62, 63) of a hydrocarbon production system has two reprogrammable central controllers (100) contained-in a retrievable module (49a) of a seabed facility (20′) associated with a hydrocarbon field (170). Local controllers are configured to control the operation of specific devices, such as actuators (61), sensors (62) and valves (63) within the module (49a) and within tree wellheads (30′) of the field (170) and are locally connected to these devices (61, 62, 63). A single common data bus (130) links the central controllers (100),and the local controllers and enables data to be transmitted between the central controllers (100) and the local controllers in response to the central controllers (100) receiving signals. Each local controller has a microprocessor for processing the data transmitted to it, and the processed data is transmitted between the local controller and its associated devices (61, 62, 63) in accordance with the processed data so as to locally control the operation of those device.

The present invention relates to a method and system for controlling the operation of devices in a hydrocarbon production system, and more particularly, to a system for controlling devices in a subsea system.

When developing hydrocarbon production systems, system components and devices, such as pumps, temperature sensors and the like are initially selected and a control system is subsequently designed specifically to control the operation of the selected devices. If an additional device is later required, the control system has to be replaced or upgraded unless the control system has remaining, finite, capacity. Consequently, during the initial system design stage, a best estimate of future equipment requirements has to be made. As production characteristics vary enormously throughout field life, it is impossible to know exactly when or if new equipment will be required, in fact, by the time additional equipment is required, the desired specification of the additional equipment may be completely different to that identified during initial design. It is therefore desirable to design a system that can cater for incremental field development without the need to shut down the system due to hardware changes.

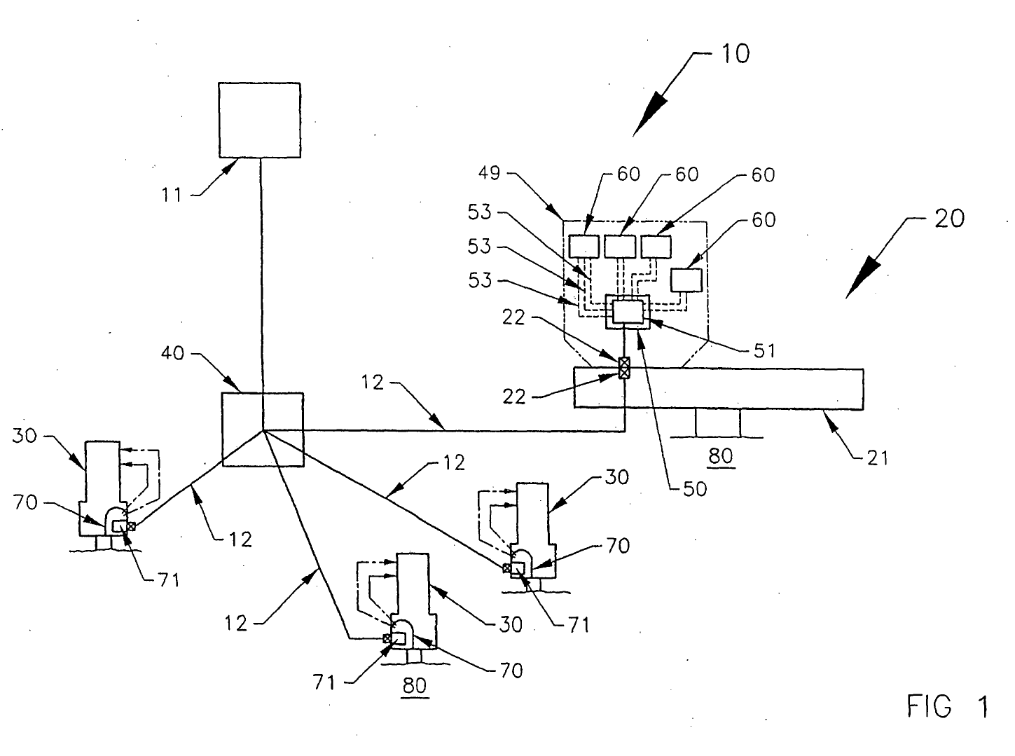

FIG. 1. of the accompanying drawings, shows an existing control system for controlling a single field of a subsea hydrocarbon production system 10. A host facility 11, which may be, for example, onshore or on a fixed or floating rig, has a master control station and a power supply (not shown) which are connected to a remote seabed facility 20 and wellhead trees 30 on the seabed 80, via a remote subsea distribution module (SDM) 40 by power and signal cables 12. Fluid pipelines (not shown) are connected from the host facility to the seabed facility 20 and the wellhead trees 30 so as to allow fluid to be passed around the system under control of the control system.

The seabed facility 20 comprises a retrievable module 49 connected to a base structure, in this case a manifold 21, on the seabed 80 by cable connectors 22 and a multi-ported fluid connector (not shown). In the example shown in FIG. 1, the module 49 contains a subsea control module (SCM) and of the general type forming part of a modular system for subsea use designed by Alpha Thames Limited of Essex, United Kingdom, and referred to as AlphaPRIME.

The SCM 50 contains a subsea electronic module (SEM) 51 which contains hardware and software and which is designed exclusively to control the operation of specific devices 60 which are contained in the SCM 50 or which are to be added based on possible future requirements of the system as determined when the SEM 51 is first installed in the module 49. The devices 60 may include electrically actuated valves manufactured under the names PROACT and REACT by Alpha Thames Limited and separators. Messages are passed back and forth to the host facility by the SEM of the SCM.

Further SCMs 70 and SEMs 71 which comprise simple electronic circuits are also contained within the wellhead trees 30 themselves and receive the electrical signals from the SEM 51 of the SCM 50 to operate other devices, such as valves and sensors (not shown), contained in the wellhead trees. The wellhead trees 30 connect onto the SDM 40 to provide their communications. All communication to and from the trees 30 has to pass via the host facility 11.

The number of devices which can be controlled is limited by the capacity of the SEM. The SCM is a thin walled oil filled, pressure balanced hydraulic device. Conventionally, the SCM receives high pressure hydraulic fluid from the host to power the hydraulically operated valves on the tree/manifold. The SEM is a gas filled thick walled pressure, vessel normally comprising a cylinder of approximately 100 mm diameter containing electron capacity in the form of microchips, printed circuit boards etc. The electronics in. the STEM receive control signals from the host and convert these into simple electrical signals that operate simple shuttle valves, etc contained in the SCM to control the high pressure hydraulic fluid to open and close production valves on the wellhead trees. The design engineer has to predict the expansion of controlled equipment likely over the field life on the manifold and wellhead trees However, every additional connection to the SCM 50,70 and SEM 51,71 contained therein are additional failure points, and so possible future expansion is weighed against system reliability.

There are also limitations on the size of the field. Subsea distribution modules (SDM) can be chained together to connect more SCMs 50,70 and SEMs 51,71 together but with each additional unit there is an additional loss, so there is a finite size to the field.

The SEMs 51,71 of the SCMs 50,70 have physical limits on the number of connections that can be made to devices. Cables have to exit the casing of the SEM, via penetrators. As the SEM is at atmospheric pressure and the outside pressure could be 300 times that, the cross section of the penetrator must be as small as possible. As the cross sectional area increases the effect of the outside pressure will be to push the penetrator or cables through the wall of the SEM and into the SEM and compromise the seal. As more and more cables are required to connect to outside devices the cost to seal the SEM 51,71 of theSCM 50,70 increases. Shown on FIG. 1 are lines between the SEM of the SCM and the devices 60. Each line comprises a bundle of cables 53 to control the device. Each bundle requires an SEM penetrator, on a basic system there could be 15 or more penetrators, which significantly increases the complexity and cost of the system.

As technology is progressing at a significant pace, current field development control systems limit the ability to add new functionality. or new technology.

In order to embrace new technology, particularly for subsea field developments, it is important to have readily maintainable and upgraedeable modular systems that can allow for future expansion as equipment improves over time. It is also important to ensure that the control and powering of these systems also takes a modular form and can keep pace with system changes without the need to change the hardware during field life.

There is a need to provide a method and system for controlling devices of a hydrocarbon production system which enables the production system to be upgraded or modified over time without recourse to changes in instrument and control hardware.

According to one aspect, the present invention consists in a method for controlling the operation of devices of a hydrocarbon production system, comprising the steps of:

(a) connecting at least one central controller to at least one local controller, the central controller(s) being reprogrammable and the local controller(s) being configured to locally control the operation of at least one respective device,

(b) transmitting data between the central controller(s) and the local controller(s) in response to said central controller(s) receiving signals

(c) processing said transmitted data at the local controller(s), and

(d) transmitting data between the local controller(s) and its associated device(s) according to the processed data so as to locally control the operation of the devices(s).

By using a local controller to locally control specific devices and reprogrammable central controllers to control, the local controllers control of existing devices can be modified or new devices and their local controllers can be subsequently added to any part of the system without requiring hardware changes to the central controllers.

Preferably, the method step (b) includes transmitting data between the central controller(s) and the local controller(s) in response to said central controller(s) receiving signals from n any other central controller, or alternatively or additionally from the local controller(s). The method according to this latter mentioned feature allows the central controller(s) to operate independently of a host facility.

Additionally, the method may include the steps of:

(e) connecting a remote master controller to the central controller(s),

(f) transmitting data between the master controller(s) and the central controller(s) so as to remotely monitor the central controller(s).

Alternatively or additionally, the method may include the steps of

(g) transmitting data between the remote master controller(s) and the central controller(s) so as to reprogram the central controller(s) to enable newly added devices and their local controllers to be used in the aforementioned method or to enable the central controller(s) to control existing local controllers in a different manner.

Preferably, the method includes a step of feeding back data signals from the device(s) to the local controller(s), for example, in response to the device(s) receiving data or activating.

Also preferably, the method includes the step of feeding back data signals from the local controller(s) to the central controller(s), for example, in response to the local controller(s) receiving feedback data signals from its associated device(s) or from the central controller(s).

Additionally, the method step (d) may include controlling the device(s) by activating or powering a sensor or valve, actuating a compressor, pump or actuator.

In a preferred embodiment, at least two central controllers are contained in one or more subsea control modules of retrievable modules of one or more field developments. The central local controllers are microprocessors or central processing units. Local controllers are connected to their associated devices such as, motors, temperature sensors, pressure sensors, or magnet valves, which are contained in the or each control module itself, in wellhead trees and any other type of subsea apparatus suitable for use with a subsea hydrocarbon production system. The method of the invention enables the devices and their local controllers to be connected to the or each central controller via a common data bus so that the number and size of penetrators used in the system can be kept to a minimum.

Additionally, in the preferred embodiment the method may include the step of connecting the central controller of one subsea control module to one or more central controllers contained in one or more other subsea control modules in the same or another field development, transmitting data between any of the central controllers and any of the local controllers contained in one of said subsea modules or a tree of the same or another field development. For example, the method may include the step of transmitting data from a sensor to its local controller in response to the sensor detecting an excess of fluid in a first field, transmitting data from the local controller back to a first central controller of a subsea control module of the first field, transmitting data between the first central controller and one or more other central controllers contained in any subsea control modules in the same and other fields to determine a second field which has a shortage or suitable outlet, and transmitting data between the first central controller and other local controllers in the same and other fields so as to control a device in the second field to allow excess fluid to be transferred from the first field to the second field.

According to another aspect, the present invention consists in a system for controlling the operation of devices of a hydrocarbon production system, comprising:

(a) connecting, means for connecting at least one central controller to at least one local controller, the central controller(s) being reprogrammable and the local controller(s) being configured to locally control the operation of at least one respective device,

transmitting means for transmitting data between, the central controller(s) and the local controller(s) in response to said central controller(s) receiving signals,

(c) processing means for processing said transmitted data at the local controller(s), and

(d) transmitting means for transmitting data between the local controller(s) and its associated device(s) according to the processed data so as to locally control the operation of the device(s).

Preferably, the system includes control means for remotely controlling the central controller(s) and transmitting means for transmitting data between the master control means and the central controllers so as to remotely monitor the central controller(s).

Alternatively or additionally, a system may include transmitting means for transmitting data between the master controlling means and the central controller(s) so as to reprogram the central controller(s) to enable new devices and their local controllers to be controlled by the central controller(s) or to enable the central controller(s) to control the existing local controller(s) and in a different manner.

Preferably, the system includes means for feeding back data signals from the device(s) to the local controller(s) and from the local controller(s) to the central controller(s).

According to yet another aspect, the present invention comprises a computer program product comprising program code means stored in a computer readable medium for performing a method according to any one of the method steps of any one of the aforementioned methods when that product is run on a computer.

The invention will now be described, by way of example, with reference to the accompanying drawings, in which:

FIG. 1 is a schematic diagram of a subsea hydrocarbon production system according to the prior art;

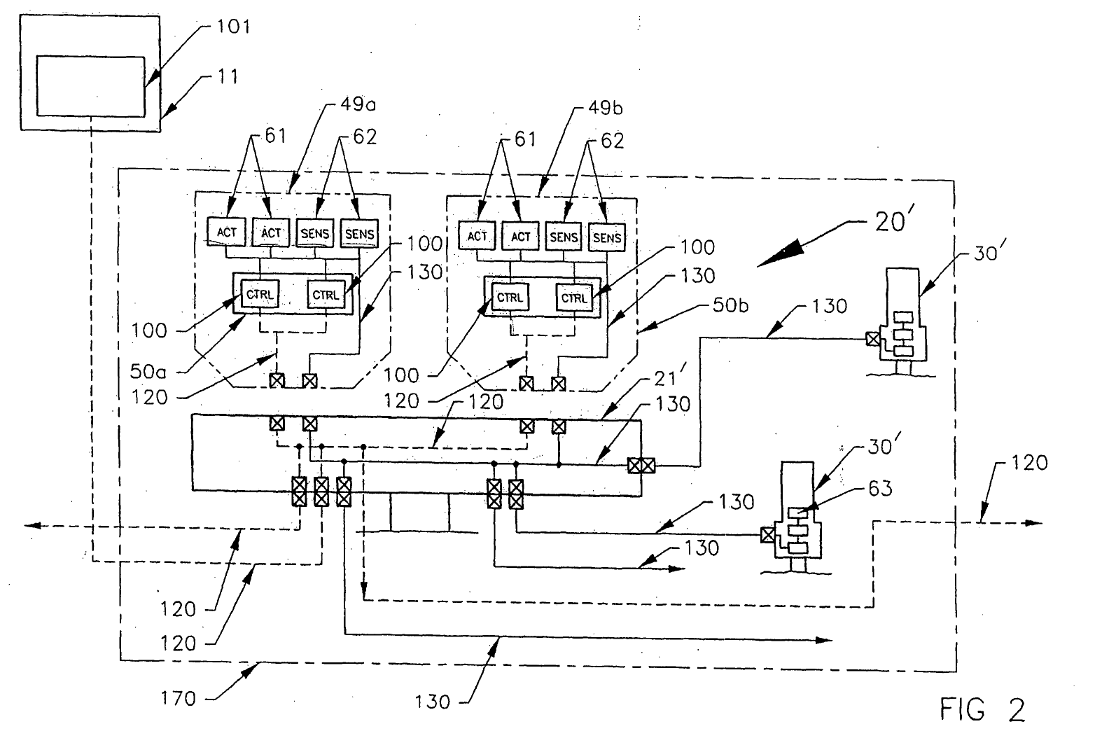

FIG. 2 is a schematic diagram of a system according to a preferred embodiment of the present invention;

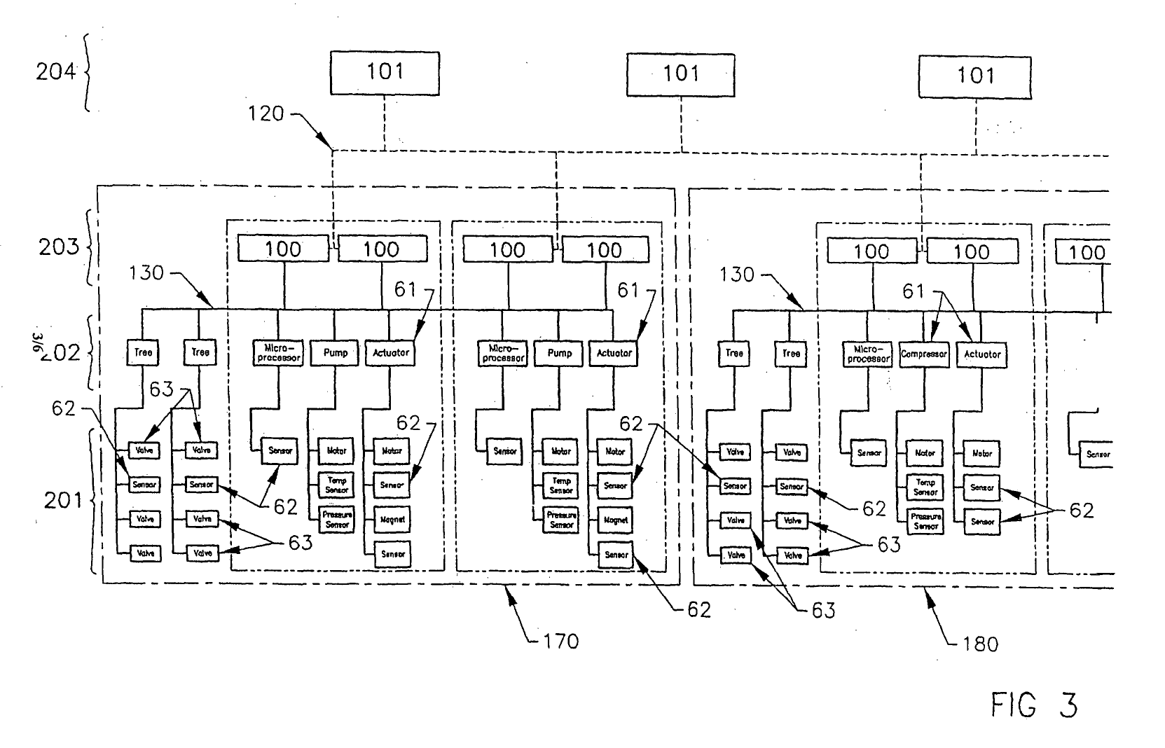

FIG. 3 is a block diagram showing the logical layout of the system shown in FIG. 2;

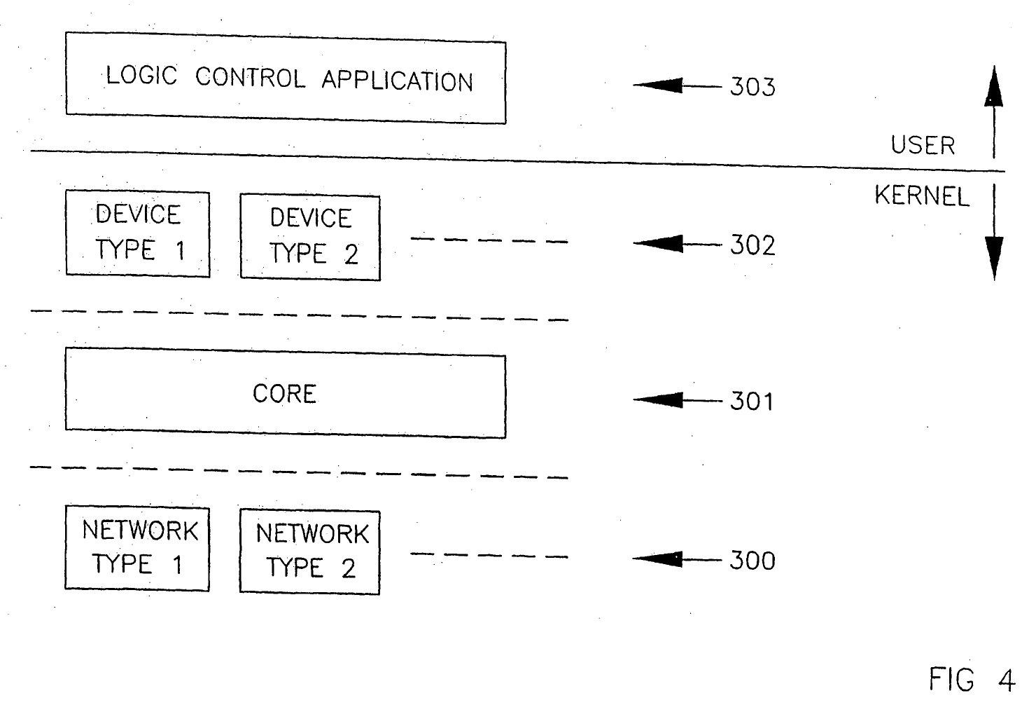

FIG. 4 is a block diagram showing the logical layout and interaction of the first layers of the software which is run on the system of FIG. 2;

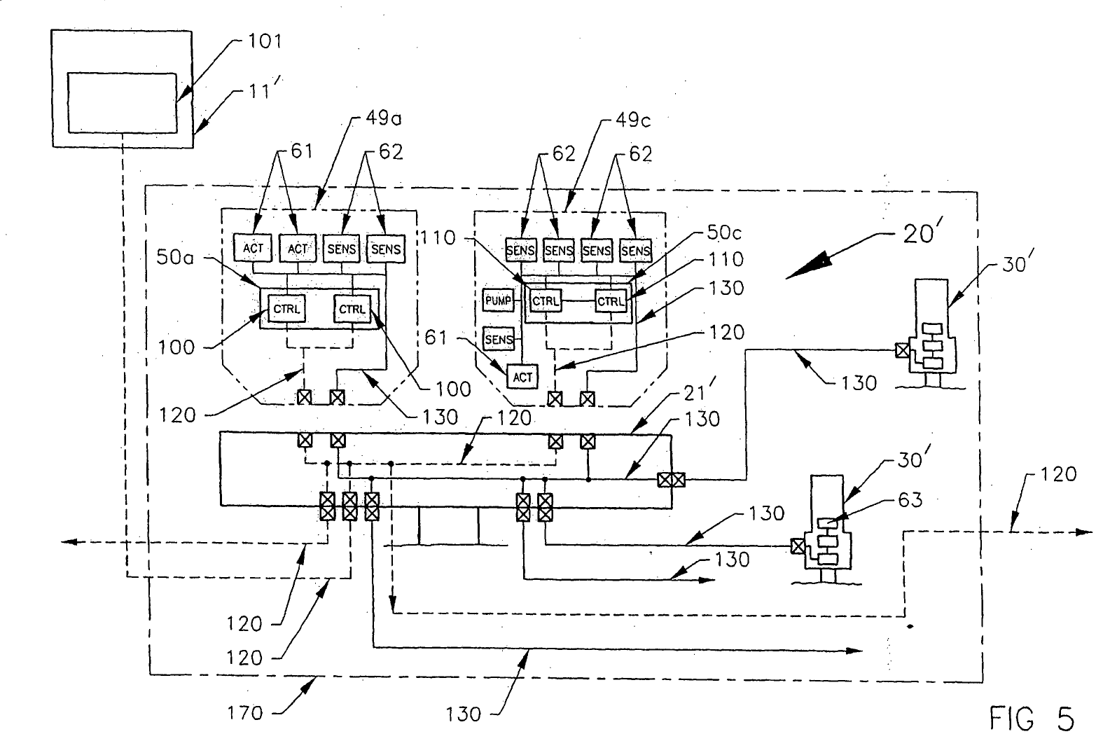

FIG. 5 is a schematic diagram of the system of FIG. 2 but with one of the system modules reconfigured to include several additional local controllers and devices; and

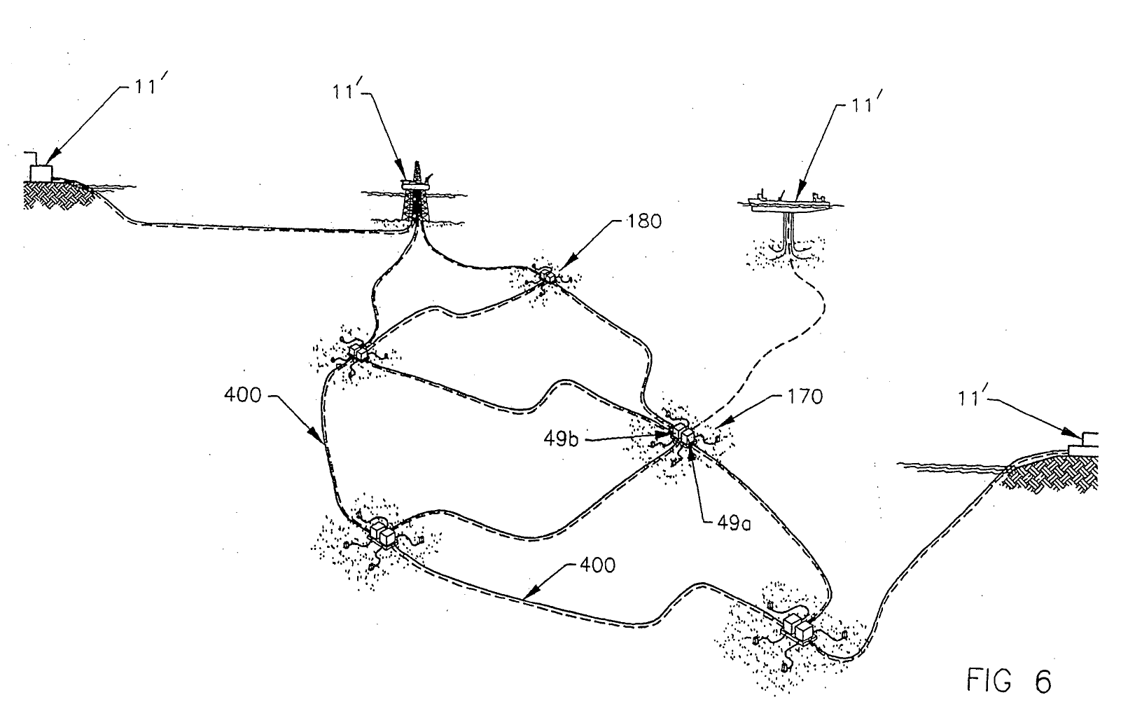

FIG. 6 is a schematic diagram showing adjacent fields connected to each other by pipelines, power lines and communication lines.

Referring to FIG. 2 of the accompanying drawings, the system for controlling the operation of a hydrocarbon system has two central controllers 100 contained in a first subsea control module 50a of a retrievable module 49a which is connected to a manifold 21′ of a seabed facility 20′. A command/signal bus 120 links a master control station 101 contained in a host facility 11′ to each of the central controllers 100 of the first retrievable module 49a via a manifold 21′. The host facility 11′ is, for example, onshore or on a fixed or floating rig and the master control station 101 comprises a processing means which, in this embodiment, is a central processing unit. The command/signal bus 120 also links the central controllers 100 of the first retrievable module 49a and the master control station 101 to any other master control station (not shown) and any other central controller existing in the same170 or a different field.

Local controllers are locally connected to one or more specific devices, such as actuators 61, sensors 62, valves 63 and pumps (not shown) contained within the first retrievable module 49a and within each tree wellhead 30′. The local controllers and the central controllers 100 are linked to a common data bus 130 so that data may be transmitted between the central controllers 100 and the local controllers and between the central controllers 100 themselves. Furthermore, the one or more specific devices can only communicate via the single common data bus 130 to local central controllers 100 within that field 170 and communications between the field 170 and any other field (not shown) is via the command/signal bus 120.

Each local controller comprises a processing means, such as a microprocessor, which is appropriately programmed to permit it locally to control and run its associated device or devices 61-63 in response to simple commands which are sent to it from one of the central controllers 100;

Thus, instead of all the processing power of the control system being in a central place, the devices 61-63 of the system are controlled locally by local controllers which have their own processing power. Each local controller has enough processing power and programming to control the device or devices 61-63 which are locally connected to it. All commands issued to each device 61-63 can be as simple as move here, do this etc. Each device 61-63 can be queried for its current status, during or after a procedure. Feedback when a device has finished a command can also be fed back to the central controllers 100 via the local controllers. As will be explained more fully below, this, means that any processing which is specific to a device 61-63 can be performed within its local controller. The central controllers 100 therefore only require new software and not new hardware to control a new device.

As shown in FIG. 2, a second retrievable subsea module 49b which is identical to the first module 49a is connected to the manifold 21′ at a position adjacent to the position at which the first module 49a is connected so that if the first module 49a becomes inoperable, for example through failure or as a consequence of it being retrieved for servicing, a second module 49b can be used to perform all the functions of the first module without interrupting operation of the production system. To this end, the central controllers 100 of the second module 49b are connected to the common command/signals bus 120 so that the master control station(s) 101 may transmit the command/signals to not only the central controllers 100 of the first module but also the central controllers 100 in the second module 49b. Likewise, the local controllers and central controllers 100 contained in the second module 49b are connected to he common data bus 130 so that data can be transmitted between the central controllers 100 of the second module 49b and between any other central controller 100 and between the local controllers contained in the second module 49b and any other central controller.

FIG. 3 shows the logical layout of the system of the field 170 shown in FIG. 2 and part of an additional field 180. The layout is split into four layers. At the bottom is the Device Layer 201. This layer contains all the sensors 61-63, motors etc for each device, i.e. the components of each device. The next layer up is the Device Control Layer 202. This is the layer that contains the local controller for each device 61-63. Each local controller is programmed to deal with the functionality of the device 61-63. These two layers 201,202 may be combined to provide so called “Smart Devices”. The next layer up is the system control layer 203. This contains the central controller 100 that binds the Smart Devices together and makes them perform their tasks according to the system programming.

Redundancy is provided by a voting system between central controllers 100 contained within the subsea system. The voting system is based on the central controllers 100 in different subsea control modules of the same field 170 communicating with each other to provide a mechanism whereby a controller 100 that is found to beat fault is ignored.

The top layer shown in FIG. 3 is the Master Control Layer 204. Monitoring is performed here and system configuration changes are deployed from here. In this embodiment, many master controllers 101 are monitoring the subsea systems, or selectively monitoring their specific field development. Throughout this network, communication is only possible between device/controllers at the same level or on immediately adjacent levels.

FIG. 4 shows the logical layout and interaction of the various, layers of the software portion of the invention. The “Connectivity layer” 300 standardises the interface to the network. This functions as an abstraction layer so that many different types of networking can be used. The “Core Layer” 301 sits on top of the “Connectivity Layer”. This layer 301 provides many functions. Firstly it unifies the network connections together. Secondly it provides another abstraction layer, at this layer 301 local controller discovery and communication etc is provided. Anything common to all local controllers is provided here. The final layer that makes up the “Kernel” portion of the system is the “Device Driver Layer” 302. At this layer 302, many local controller drivers are provided, These provide the specific control, and feedback, to the local controller the driver is written for New devices and their local controllers can be added by just adding a new driver to the central controllers.

The next layer 303, which exists in user portion of the system, is the application that runs the local controllers and communicates with the other control systems, subsea units and hosts.

The use of “Kernel” and “User” programming techniques allows this to be implemented using current embedded computing technology.

Software programmes allow the local controller drivers to be readily updated without the need to change control hardware. These also allow the is central controllers to operate all the local controllers and allow for new devices and their local controllers to be added in the system. Furthermore the programs allow the central controllers 100 to operate independently of host equipment.

The central controllers 100 can also communicate with each other, via a common data bus 130, in a voting system to agree on commands to devices and ensure that commands from a controller that is issuing commands in error is ignored.

Central controllers 100 can communicate with central controllers 100 of other subsea units via the command/signal bus 120 to enable the control of a nodal subsea hydrocarbon productionl system to be effected. Such a system may include a network of subsea units connected to one or more host or fluid receiving facilities by a network of pipelines and control lines connected to permit fluids to be selectively routed through the network in a manner dependent on subsea unit requirements and other requirements. The topside host is only for monitoring, system configuration and issuing commands. Software architecture is also modular and standardised to allow for easy addition of new devices.

FIG. 6 of a nodal subsea hydrocarbon productions system shows how adjacent fields can be connected to each other by a number of pipelines, power lines and communication lines to make the best use of existing infrastructure and to avoid the need for long and costly lines back to specific (possibly distant) host facilities. By enabling communication and control between the local controllers and central controllers on the fields 170,180, paths can be setup within a mesh or network of pipelines 400 (shown with solid lines) to permit excess fluid to be transferred from one field 170 to another 180 which has a shortage or suitable outlet, e.g. excessive water produced at one field can be transferred to a field which is injecting water for reservoir pressure maintenance or for disposal. Similarly, this mesh of lines may permit alternate routes to be provided for fluid, power or communications should a problem occur with the, existing route communication lines are shown with dotted lines.

Methods for controlling the operation. of devices of a hydrocarbon production system according to preferred embodiments will now be described with reference to the Figures of the accompanying drawings.

Referring to FIG. 2, initially, a central controller 100 of the first subsea module 49a is connected to a local controller of a valve 63 contained in a tree 30′ when the module 49a is appropriately docked with the manifold 21′. The central controller 100 receives signals fed back on the common data bus 130 from a sensor 62 contained in the first subsea module 49a via the sensor's local control module. Data is then transmitted between the central controller 100 and the local controller of the valve 63. The local controller of the valve then processes the transmitted data and data is then transmitted between it and the valve 63 so as to locally control the operation of the valve 63.

When remote monitoring of the system is required, the remote master control station 101 is connected to the central controller 100 of interest and data is transmitted between the master control station 101 and the central controller of interest on the command/signal data bus 120 so as to remotely monitor the central controller and any other controllers or devices connected to it.

In order to reprogram a central controller 100, a remote master control station 101 is connected to the central controller of interest and data is transmitted between the master control station and the central controller on the command/signal bus 120 so as to reprogram the central controller for the aforementioned purposes.

In order to upgrade the field without significant disruption to production, the subsea module 49b shown in FIG. 2 is retrieved and reconfigured to include several additional devices 64 and their local controllers. The local controllers are added to the data bus within the module 49c and the relevant drivers and updated control program are installed. The reconfigured module 49c is then installed on the field and commissioned. FIG. 5 shows the reconfigured subsea module 49c. Once fully operational, the control program is updated in the non-reconfigured module 48a so that normal operation including voting, and redundancy, etc is restored. In due course, the other module 48a can be reconfigured in a similar manner.

Referring to FIGS. 2 and 6, a central controller 100 of one subsea control module 48a is connected to central controllers 100 contained other subsea control modules in the same and other field developments 170,180. Data is fed back on the data bus 130 from a sensor 62 via its local controller to a first central controller 100 contained in the subsea control module 48a in response to the sensor 62 detecting an excess of fluid in the field 170. The first central controller or master control station 101 of the first field 170 communicates with the other central controllers of all the fields to determine a second field which has a shortage of fluid or a suitable outlet. Data is then transmitted between the first central controller and other central controllers 100 contained in subsea control modules in other fields. Data is then transmitted between the second central controller of the first field 170 and local controllers in the first and other fields so as to control valves 63 in the first and other fields to allow excess fluid to be transferred from the first field to the second field.

The system for controlling the operation of a hydrocarbon system may enable routing of fluids to be changed, and this needs to be confirmed via the master control station 101 in a host facility 11′.

1. A method for controlling the operation of devices (61,62,63) of a hydrocarbon production system, comprising the steps of:
(a) connecting at least one central controller (100) to at least one local controller, the central controller(s) (100) being reprogrammable and the local controller(s) being configured to locally control the operation of at least one respective device (61,62,63),
(b) transmitting data between the central controller(s) (100) and the local controller(s) in response to said central controller(s) (100) receiving signals,
(c) processing said transmitted data at the local controller(s), and
(d) transmitting data between the local controller(s) and its associated device(s) (61,62,63) according to the processed data so as to locally control the operation of the device(s) (61,62,63).

2. The method as claimed in claim 1, wherein method step (b) includes transmitting data between the central controller(s) (100) and the local controller(s) in response to said central controller(s) (100) receiving signals from any other central controller, and/or from the local controller(s).

3. The method as claimed in claim 1 or 2, including the step of connecting at least one remote master controller (101) to the central controller(s) (100).

4. The method as claimed in claim 3, including the step of transmitting data between the master controller(s) (101) and the central controller(s) (100) so as to remotely monitor the central controller(s).

5. The method as claimed in claim 3 or 4, including the steps of adding at least one device (64) and its associated local controller(s) to the hydrocarbon production system, transmitting data between the remote master controller(s) (101) and the central controller(s) (100), and reprogramming the central controller(s) (100) to enable said newly added device(s) (64) and its local controller(s) to be used in the method.

6. The method as claimed in claim 3, 4 or 5, including. the steps of transmitting data between the remote master controller(s) (101) and the central controller(s) (100), and reprogramming the central controller(s) (100) to enable the central controller(s) (100) to control existing local controllers in a different manner.

7. The method as claimed in any preceding claim, including the step of feeding back data signals from the device(s) (61,62,63) to the local controller(s).

8. The method as claimed in any preceding claim, including the step of is feeding back data signals from the local controller(s) to the central controller(s) (100).

9. The method as claimed in any preceding claim, wherein method step (d) includes controlling the device(s) (61,62 63) by at least activating or powering a sensor (62) and/or valve (63), and/or actuating a compressor, pump and/or actuator (61).

10. The method as claimed in any preceding claim, including the step of connecting the central controller (100) of one subsea control module (50a). to one or more central controllers (100) contained in one or more other subsea control modules (50b) in the same or another field development (170,180), and wherein method step (b) comprises transmitting data between any of the central controllers (100) and any of the local controllers contained in a retrievable module (48a,49b) or a tree (30′) of the same or another field development (170,180).

11. A system for controlling the operation of devices (61,62,63) of a hydrocarbon production system, comprising:
(a) connecting means (130) for connecting at least one central controller (100) to at least one local controller, the central controller(s) being reprogrammable and the local controller(s) being configured to locally control the operation of at least one respective device (61,62,63),
(b) transmitting means (130) for transmitting data between the central controller(s) (100) and the local controller(s) in response to said central controller(s) (100) receiving signals,
(c) processing means for processing said transmitted data at the local controller(s), and
(d) transmitting means for transmitting data between the local controller(s) and its associated device(s) (61,62,63) according to the processed data so as to locally control the operation of the device(s).

12. The system as claimed in claim 11, including control means (101) for remotely controlling the central controller(s) (100) and transmitting means (120) for transmitting data between the master control means (101) and the central controller(s) (100).

13. The system as claimed in claim 11 or 12, including means (130) for feeding back data signals from the device(s) (61,62,63) to the local controller(s) and from the local controller(s) to the central controller(s) (100).

14. A computer program product comprising program code means stored in a computer readable medium for performing a method according to any one of the method steps as claimed in any one of claims 1 to 10 when that product is run on a computer.
